(19) United States
(12) Patent Application Publication
(10) Pub. No.: US 2003/0141636 A1
(43) Pub. Date: Jul. 31, 2003

(54) Apparatus and method for vacuum blow molding

(76) Inventor: Michael E. Jimmerson, Woodbury, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/375,156

(22) Filed: Feb. 27, 2003

(51) Int. Cl. B29C 49/00

(52) U.S. Cl. 264/526; 425/522

(57) ABSTRACT

An apparatus and method for vacuum blow molding that utilizes vacuum force to hold, and thus, preclude movement of the parison within the mold cavity, whereupon highly-pressurized or compressed air is utilized to forcefully pierce the parison for expansion and conformation of the parison to the mold interior, thus affording consistent and uninterrupted production of the desired blow molded product without dependency upon blow pins or hollowed needles as utilized in prior art methods and machinery for blow molding processes.

### TECHNICAL FIELD

The present invention relates generally to molding processes, and more specifically to an apparatus and method for vacuum blow molding. The present invention is particularly suitable for, although not strictly limited to, forming hollow plastic articles.

### BACKGROUND OF THE INVENTION

In general, blow molding is a method of forming hollow products or articles from thermoplastic materials. The process of blow molding typically involves extruding a molten tube of thermoplastic material, commonly referred to as parison, from the die head of a blow molding machine, wherein the tube or parison is subsequently expanded within a chilled mold cavity via compressed air to produce the molded part. Although several methods and associated machineries are utilized to infuse the parison with compressed air for conformation of the parison to the blow mold, such available methods and machinery possess inherent disadvantages that make implementation and use of same highly inefficient, impractical and problematic.

For instance, the method of continuous-extrusion blow molding involves a continuously running extruder having a tuned die head for formation of the molten plastic tube or parison, wherein the parison is then pinched between two mold halves. Thereafter, a blow pin or hollowed needle is forcefully inserted through ports in the mold in attempts to pierce the parison for injection of compressed air therein for expansion and conformation of the parison to the chilled mold interior.

However, as is commonly experienced by manufacturers of blow molded products, utilization of such blow pins or hollowed needles for penetration of the parison for injection of compressed air therein typically results in an overall inefficient manufacturing process. More specifically, when initially extruded and pinched off between the blow mold, the inherently high temperature of the molten parison gives the parison an overall “soft” or pliable consistency. As such, the blow pins or hollowed needles are often unable to pierce the soft surface of the parison, and instead, push the parison forward within the mold cavity. Unfortunately, it is only after the cooling process of the parison, and opening of the mold, that the manufacturers realize that the parison was not pierced by the blow pins, and thus not blown to the desired mold shape. As such, the unformed, cooled parison must then be returned to the extruder for re-melting and subsequent re-extrusion as a molten parison, whereby the blow molding process is repeated until the blow pins effectively pierce the molten parison to form the blow molded product. As the system must be halted for an indefinite period pending removal of the unformed parison and resetting of machine operational systems, such a process bears obvious ramifications and undue expense to the manufacturer.

Therefore, it is readily apparent that there is a need for an apparatus and method that effectively and efficiently blow molds parison to conform to the mold cavity, wherein the apparatus and method provides a means that effectively and consistently pierces the parison for uninterrupted production of the desired blow molded product, and wherein dependency of blow pins or hollowed needles are completely eliminated as the means of delivery of compressed air.

### BRIEF SUMMARY OF THE INVENTION

Briefly described, in a preferred embodiment, the present invention overcomes the above-mentioned disadvantages and meets the recognized need for such a device by providing an apparatus and method for vacuum blow molding that utilizes vacuum force to hold, and thus, preclude movement of the parison within the mold cavity, whereupon highly-pressurized or compressed air is utilized to forcefully pierce the parison for expansion and conformation of the parison to the mold interior, thus affording consistent and uninterrupted production of the desired blow molded product without dependency upon blow pins or hollowed needles as utilized in prior art methods and machinery for blow molding processes.

According to its major aspects and broadly stated, the present invention in its preferred form is an apparatus and method for vacuum blow molding having vacuum means and compressed air delivery means.

More specifically, the present invention is an apparatus and method for vacuum blow molding comprising a blow mold having a first and second vacuum means concentrically disposed about a first and second compressed air delivery means, respectively. Upon pinching off the parison between the two mold halves, the first and second vacuum means preferably apply a vacuum force to hold, and thus, preclude movement of the parison within the blow mold cavity, whereupon the first and second compressed air delivery means deliver a highly-pressurized air that forcefully pierces the parison for infusion of air therein, thus permitting expansion and conformation of the parison to the blow mold interior.

Accordingly, a feature and advantage of the present invention is its novel and non-obvious use of highly-pressurized or compressed air to forcefully pierce the parison for expansion and conformation of the parison to the blow mold interior.

Another feature and advantage of the present invention is its ability to provide a blow molding process that eliminates dependency upon blow pins or hollowed needles as the means of delivering compressed air into the parison.

Another feature and advantage of the present invention is its ability to provide an apparatus and method that effectively and consistently pierces the parison for uninterrupted production of the desired blow molded product.

Another feature and advantage of the present invention is its novel and non-obvious use of vacuum force to hold, and thus, preclude movement of the parison within the mold cavity for subsequent piercing and infusion by compressed air.

Another feature and advantage of the present invention is its ability to be utilized in blow molding of any suitable material, including, but not limited to, plastic, metal, glass, or any other applicable polymer.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a vacuum blow molding apparatus according to a preferred embodiment of the present invention; and,

FIG. 2 is a perspective view of a vacuum blow molding apparatus according to an alternate embodiment of the present invention.

### DETAILED DESCRIPTION OF THE PREFERRED AND ALTERNATIVE EMBODIMENTS

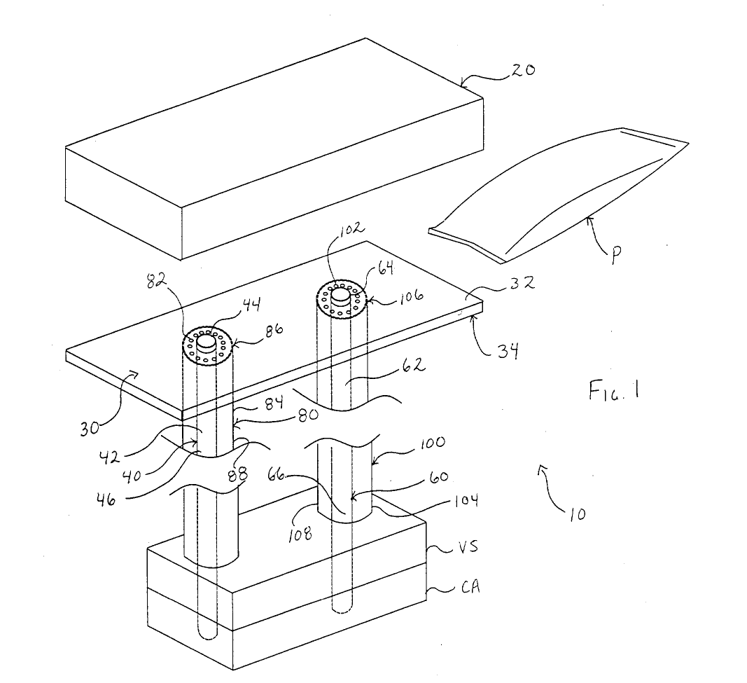

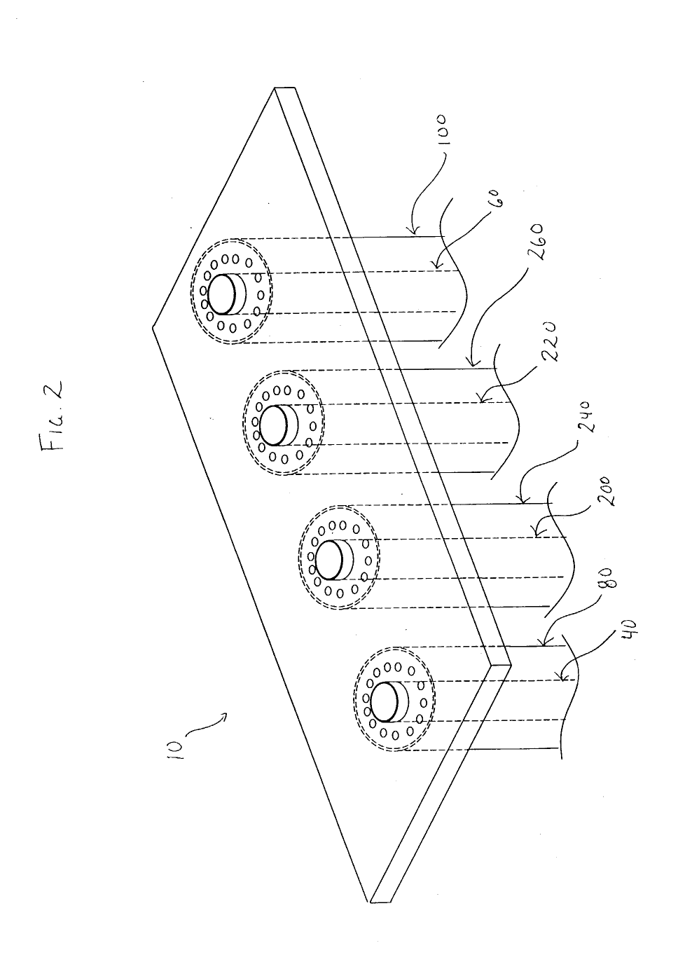

In describing the preferred and a selected alternate embodiment of the present invention, as illustrated in FIGS. 1-2, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in a preferred embodiment is an apparatus 10 utilized for implementation of the preferred method of vacuum blow molding as herein described. Preferably, apparatus 10 possesses first and second blow mold portions 20 and 30, respectively, first and second compressed air delivery means 40 and 60, respectively, and first and second vacuum means 80 and 100, respectively.

As illustrated in FIG. 1, blow mold portions 20 and 30 are substantially rectangular-shaped, and thus, are best suited for blow molding a substantially rectangular-shaped hollow article; however, it should be recognized that alternate, equally effective, blow mold configurations and/or shapes could be utilized without departing from the appreciative scope of the present invention, as such additions and/or modifications to blow mold configurations and/or shapes are known within the art and in full contemplation of the inventor in describing the present invention herein, wherein such alternate shapes and/or configurations could be, for exemplary purposes only, circular-shaped, oval-shaped, diamond-shaped, bottle-shaped, ring-shaped, sphere-shaped, animal-shaped, vehicle-shaped, and/or any other shape or configuration desired for manufacture of any desired blow mold article.

Blow mold portions 20 and 30 are preferably formed from a durable metal; however, blow mold portions 20 and 30 could be formed from other suitable materials adapted to withstand the temperatures, pressures and operational conditions common to conventional blow molding processes. As more fully described below, following extrusion of a molten tube of thermoplastic material, or parison P, from a conventional extruder, blow mold portions 20 and 30 preferably engage and pinch off parison P, enclosing parison P therein, as is known within the art.

Preferably disposed on second blow mold portion 30 are first and second compressed air delivery means 40 and 60, respectively, and first and second vacuum means 80 and 100, respectively. Although second blow mold portion 30 has some formative function in the aesthetic development of parison P into the desired article of manufacture, first portion 20 preferably substantially influences the overall aesthetic shape or configuration of the manufactured article, defining the limits to which parison P may be blown or expanded via first and second compressed air delivery means 40 and 60. However, it should be appreciated that depending upon the article to be manufactured, both first and second blow mold portions 20 and 30, respectively, may play a significant formative role in the final aesthetic shape and/or configuration of the manufactured or blow molded article.

Preferably, first and second vacuum means 80 and 100 are concentrically disposed about first and second compressed air delivery means 40 and 60, respectively, wherein first vacuum means 80 and respective first compressed air delivery means 40 are preferably distanced from second vacuum means 100 and respective second compressed air delivery means 60 to provide balanced interaction with parison P, as more fully described below. Although first and second vacuum means 80 and 100, respectively, and first and second compressed air delivery means 40 and 60, respectively, are preferred, it is contemplated in an alternate embodiment that any number of vacuum means and corresponding compressed air delivery means may be disposed on second blow mold portion 30 and/or first blow mold portion 20 and utilized for vacuum blow molding of parison P without departing from the appreciative scope of the present invention, as such additions and/or modifications are in full contemplation of the inventor in describing the present invention herein.

Preferably, first compressed air delivery means 40 possesses a rigid hollow tube 42 disposed through second blow mold portion 30, wherein tube 42 preferably possesses first end 44 that extends preferably approximately ⅛^{th} inch past inner surface 32 of second blow mold portion 30 to permit contact of parison P therewith, as more fully described below. Although it is preferred that first end 44 of tube 42 extend approximately ⅛^{th} inch past inner surface 32 of second blow mold portion 30, it must be recognized that first end 44 could extend any distance past inner surface 32, or could alternatively be flush therewith, depending upon the article to be blow molded, and/or application of apparatus 10 in general. Preferably, the bulk of tube 42 is positioned past outer surface 34 of second blow mold portion 30, wherein second end 46 of tube 42 is preferably coupled to a controlled compressed air delivery source CA as commonly utilized in blow molding processes. Tube 42 is preferably formed from a durable metal; however, tube 42 could be formed from other suitable materials adapted to withstand the temperatures, pressures and operational conditions common to conventional blow molding processes.

Preferably, first vacuum means 80 possesses a plurality of vacuum ports 82 radially disposed about first end 44 of tube 42 of first compressed air delivery means 40, and preferably formed through second blow mold portion 30. Preferably, first end 86 of rigid vacuum tube 84 is preferably in vacuum-tight or sealed communication with outer surface 34 of second blow mold portion 30, wherein first end 86 preferably completely encircles vacuum ports 82, as best illustrated in FIG. 1. Second end 88 of vacuum tube 84 is preferably coupled to controlled vacuum source VS. As is best illustrated in FIG. 1, such a configuration results in first vacuum means 80 being concentrically disposed about first compressed air delivery means 40. Vacuum tube 84 is preferably formed from a durable metal; however, vacuum tube 84 could be formed from other suitable materials adapted to withstand the temperatures, pressures and operational conditions common to conventional blow molding and/or vacuum forming processes. Additionally, although it is preferred that vacuum ports 82 be radially disposed about first end 44 of tube 42, it is contemplated in an alternate embodiment that vacuum ports 82 could be disposed about first end 44 of tube 42 in any fashion or configuration, such as, for exemplary purposes only, star-configuration, square-configuration, or randomly disposed thereabout, so long as first end 86 of rigid vacuum tube 84 completely encloses vacuum ports 82.

Similarly, second compressed air delivery means 60 preferably possesses a rigid hollow tube 62 disposed through second blow mold portion 30, wherein tube 62 preferably possesses first end 64 that extends preferably approximately ⅛^{th} inch past inner surface 32 of second blow mold portion 30 to permit contact of parison P therewith, as more fully described below. Although it is preferred that first end 64 of tube 62 extend approximately ⅛^{th} inch past inner surface 32 of second blow mold portion 30, it must be recognized that first end 64 could extend any distance past inner surface 32, or could alternatively be flush therewith, depending upon the article to be blow molded, and/or application of apparatus 10 in general. Preferably, the bulk of tube 62 is positioned past outer surface 34 of second blow mold portion 30, wherein second end 66 of tube 62 is also preferably coupled to controlled compressed air delivery source CA. Tube 62 is preferably formed from a durable metal; however, tube 62 could be formed from other suitable materials adapted to withstand the temperatures, pressures and operational conditions common to conventional blow molding processes.

Preferably, second vacuum means 100 possesses a plurality of vacuum ports 102 radially disposed about first end 64 of tube 62 of second compressed air delivery means 60, and preferably formed through second blow mold portion 30. Preferably, first end 106 of rigid vacuum tube 104 is preferably in air-tight or sealed communication with outer surface 34 of second blow mold portion 30, wherein first end 106 preferably completely encircles vacuum ports 102, as best illustrated in FIG. 1. Second end 108 of vacuum tube 104 is also preferably coupled to controlled vacuum source VS. As is best illustrated in FIG. 1, such a configuration results in second vacuum means 100 being concentrically disposed about second compressed air delivery means 60. Vacuum tube 104 is preferably formed from a durable metal; however, vacuum tube 104 could be formed from other suitable materials adapted to withstand the temperatures, pressures and operational conditions common to conventional blow molding and/or vacuum forming processes. Additionally, although it is preferred that vacuum ports 102 be radially disposed about first end 64 of tube 62, it is contemplated in an alternate embodiment that vacuum ports 102 could be disposed about first end 64 of tube 62 in any fashion or configuration, such as, for exemplary purposes only, star-configuration, square-configuration, or randomly disposed thereabout, so long as first end 106 of rigid vacuum tube 104 completely encloses vacuum ports 102.

Upon pinching off parison P between engaged first and second blow mold portions 20 and 30, first and second vacuum means 80 and 100 preferably apply a vacuum force via vacuum source VS to hold, and thus, preclude movement of parison P within first and second blow mold portions 20 and 30, wherein vacuum ports 82 and 102 preferably function to permit vacuum source VS to draw air out from within engaged blow mold portions 20 and 30, and through vacuum tubes 84 and 104, respectively. Specifically, parison P is forcefully held against first ends 44 and 64 of tubes 42 and 62, respectively, of first and second compressed air delivery means 40 and 60, respectively, as a result of the applied vacuum force of vacuum means 80 and 100. Additionally, due to the applied vacuum force, and the inherently “soft” nature or consistency of parison P when in a molten or heated state, parison P conforms around first ends 44 and 64 at point of contact therewith. Thereafter, preferably via compressed air source CA, first ends 44 and 64 of tubes 42 and 62, respectively, preferably deliver a highly-pressurized or compressed air that forcefully pierces parison P being held thereagainst. Preferably, due to the applied vacuum force of vacuum means 80 and 100, parison P does not move while being pierced by the high-pressure compressed air of first and second compressed air delivery means 40 and 60, respectively. Following the piercing of parison P with the compressed air, compressed air source CA continues to infuse parison P with air via tubes 42 and 62, thus permitting expansion and conformation of parison P to the interior limits of blow mold portions 20 and 30.

Completion of the vacuum blow molding process of the present invention is preferably marked via implementation of conventional cooling processes and post-blow molding processes to bring the blown or molded parison P to its final manufactured form, as known within the art.

Referring now more specifically to FIG. 2, illustrated therein is an alternate embodiment of apparatus 10, wherein the alternate embodiment of FIG. 2 is substantially equivalent in form and function to that of the preferred embodiment detailed and illustrated in FIG. 1 except as hereinafter specifically referenced. Specifically, the embodiment of FIG. 2 incorporates additional compressed air delivery means 200 and 220 and corresponding vacuum means 240 and 260, respectively, formed on second blow mold portion 30; however, it is contemplated in another alternate embodiment that any number of compressed air delivery means and corresponding vacuum means may be disposed on second blow mold portion 30 and/or first blow mold portion 20 and utilized for vacuum blow molding of parison P without departing from the appreciative scope of the present invention, as such additions and/or modifications are in full contemplation of the inventor in describing the present invention herein.

It is contemplated in yet another alternate embodiment that apparatus 10 could configure or arrange compressed air delivery means 40 and 60, and/or vacuum means 60 and 100, such that they operate via a common log manifold.

It is contemplated in yet another alternate embodiment that tubes 42 and 62 of compressed air delivery means 40 and 60, respectively, could be formed from durable, flexible or pliable tubing, instead of the rigid metal material of the preferred embodiment.

It is contemplated in yet another alternate embodiment that vacuum tubes 84 and 104 of vacuum means 60 and 100, respectively, could be formed from durable, flexible or pliable tubing, instead of the rigid metal material of the preferred embodiment.

It is contemplated in yet another alternate embodiment that tubes 42 and 62 of compressed air delivery means 40 and 60, respectively, could be adapted to fill parison P with any type of gas.

It is contemplated in yet another alternate embodiment that tubes 42 and 62 of compressed air delivery means 40 and 60, respectively, could be adapted to fill parison P with liquids or solids such as, for exemplary purposes only, polystyrene or other materials, instead of, or in addition to, air.

It is contemplated in still another alternate embodiment that a plurality of vacuum ports could be formed over and through the bulk of the surface area of second blow mold portion 30, wherein a vacuum source could be in sealed communication with the entirety of outer surface 34 of second blow mold portion 30, thus conveying a substantial vacuum force therethrough for imparting additional holding force on parison P.

It is contemplated in still another alternate embodiment that apparatus 10 could be utilized for vacuum blow molding any suitable material such as, for exemplary purposes only, any suitable thermoplastic material, suitable metals, glasses, and/or other suitable polymers.

It is contemplated in still another alternate embodiment that, if desired, compressed air delivery means 40 and 60 could be equipped with blow pins or hollowed needles that would function in unison with the compressed air to both pierce and expand parison P, wherein such blow pins or hollowed needles could be placed in tubes 42 and 62 and be forcefully ejected through ends 44 and 64, respectively, thereof, and into parison P.

It is contemplated in still another alternate embodiment that parison P could be pierced and blow molded with highly pressurized or compressed air alone, without the use of vacuum force.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. An apparatus for vacuum blow molding, comprising:
at least one mold for forming a parison;
at least one vacuum means; and,
at least one air delivery means.

2. The vacuum blow molding apparatus of claim 1, wherein said at least one vacuum means and said at least one air delivery means are in communication with said at least one mold.

3. The vacuum blow molding apparatus of claim 1, wherein said at least one vacuum means assists in holding said parison in position within said at least one mold.

4. The vacuum blow molding apparatus of claim 3, wherein said at least one air delivery means pierces said parison and subsequently expands said parison to conform said parison to said at least one mold.

5. The vacuum blow molding apparatus of claim 1, wherein said at least one vacuum means is concentrically disposed about said at least one air delivery means.

6. The vacuum blow molding apparatus of claim 1, wherein said at least one air delivery means comprises at least one tube that partially protrudes into said at least one mold for contacting said parison.

7. The vacuum blow molding apparatus of claim 6, wherein said at least one vacuum means comprises a plurality of vacuum ports radially formed about said at least one tube of said at least one air delivery means, said plurality of vacuum ports adapted to hold said parison in position within said at least one mold.

8. The vacuum blow molding apparatus of claim 7, wherein compressed air forcefully ejected from said at least one tube of said at least one air delivery means pierces said parison and subsequently expands said parison to conform said parison to said at least one mold, and wherein said plurality of vacuum ports of said at least one vacuum means hold said parison in position within said at least one mold during piercing of said parison by said compressed air.

9. A method of blow molding, comprising the steps of:
a. obtaining an apparatus for vacuum blow molding, said apparatus comprising:
at least one mold for forming parison;
at least one vacuum means; and,
at least one air delivery means; and,
b. forming a parison within said at least one mold by conformation of said parison to said at least one mold via implementation of said at least one vacuum means and said at least one air delivery means.

10. The method of claim 9, further comprising the step of applying a vacuum force to said at least one mold via said at least one vacuum means, wherein applying said vacuum force results in said parison being held in position within said at least one mold.

11. The method of claim 9, further comprising the step of piercing said parison with compressed air delivered via said at least one air delivery means.

12. The method of claim 9, further comprising the step of expanding said parison with said compressed air until said parison conforms to the shape of said at least one mold.

13. The method of claim 9, wherein said at least one vacuum means and said at least one air delivery means are in communication with said at least one mold.

14. The method of claim 9, wherein said at least one vacuum means is concentrically disposed about said at least one air delivery means.

15. The method of claim 9, wherein said at least one air delivery means comprises at least one tube that partially protrudes into said at least one mold for contacting said parison.

16. The method of claim 15, wherein said at least one vacuum means comprises a plurality of vacuum ports radially formed about said at least one tube of said at least one air delivery means, said plurality of vacuum ports adapted to hold said parison in position within said at least one mold.

17. The method of claim 16, wherein compressed air forcefully ejected from said at least one tube of said at least one air delivery means pierces said parison and subsequently expands said parison to conform said parison to said at least one mold, and wherein said plurality of vacuum ports of said at least one vacuum means hold said parison in position within said at least one mold during piercing of said parison by said compressed air.

18. A method of blow molding, comprising the steps of:
a. obtaining an apparatus for vacuum blow molding, said apparatus comprising:
at least one mold for forming parison;
at least one vacuum means; and,
at least one air delivery means; and,
b. placing a parison within said at least one mold;
c. applying a vacuum force to said at least one mold via said at least one vacuum means, wherein applying said vacuum force results in said parison being held in position within said at least one mold;
d. piercing said parison with compressed air delivered via said at least one air delivery means; and,
e. expanding said parison with said compressed air until said parison conforms to the shape of said at least one mold.

19. A method of blow molding, comprising the steps of:
a. obtaining an apparatus for blow molding, said apparatus comprising:
at least one mold for forming a parison; and,
at least one gas delivery means, wherein said at least one gas delivery means comprises a jet stream of gas; and,
b. expelling gas via said at least one gas delivery means with sufficient force to rapidly penetrate the wall of said parison without deforming said parison, whereby said parison is compressed against the mold cavity of said at least one mold.
